(19) United States
(12) Patent Application Publication
(10) Pub. No.: US 2003/0174050 A1
(43) Pub. Date: Sep. 18, 2003

(54) Method for synchronizing communication stations in mutually independent power line communication (plc) networks

(76) Inventors: Bernd Bienek, Bocholt (DE); Wolfgang Groeting, Oberhausen (DE); Ralf Kern, Bocholt (DE); Werner Troks, Ladberger (DE)

Correspondence Address: MORRISON & FOERSTER LLP, 1650 TYSONS BOULEVARD, SUITE 300, MCLEAN, VA, 22102, US

(21) Appl. No.: 10/276,974

(22) PCT Filed: Apr. 23, 2001
(86) PCT No.: PCT/DE01/01535

(30) Foreign Application Priority Data
May 22, 2000 (DE) 10025282.6

(51) Int. Cl. H04M 11/04

(52) U.S. Cl. 340/310.01

(57) ABSTRACT

The invention relates to a method for rapidly synchronizing communication stations belonging to mutually independent PLC networks without reducing the user data rate. According to said method, the respective communication stations transmit or receive basic information at respectively the same time with regard to a cycle of the network frequency of each PLC network that is assigned to the respective communication station. The information is respectively transmitted with the same regularity with regard to a cycle sequence of the network frequency of each PLC network that is assigned to the respective communication station.

The invention relates to a method for synchronizing communication stations in mutually independent PLC networks according to the preamble of claim 1.

It is known to handle processes of information exchange of a verbal, pictorial or data type etc. with the aid of corresponding connecting devices, which form communication stations in this form, via the power supply system (power line) forming the basis of the respective communication stations. For this type of technical communication, the term “power line communication” (PLC) has been created.

The individual communication stations can be a part of an in each case independent communication network based on PLC technology which, for example, is associated with a company A or a company B etc. The two communication networks operate on the basis of power supply systems which, among other things, are associated with a line frequency.

In the sections following, a communication network based on the PLC technology is also called PLC network for short.

As an example of a first independent PLC network, a first personal computer (PC) and a printer will be mentioned which, for example, are located in a study and are in each case connected to the associated power supply system via a corresponding PLC modem of in each case the same company A. The PLC modems of the company A and the lines of the power supply system enable an exchange of data information to be carried out between the PC and the printer.

As an example of a second independent PLC network, a second PC and a scanner will be mentioned which, for example, are located in a living room and are in each case connected to the associated power supply system via a corresponding PLC modem of in each case the same company B.

If, for example, the second PC of the second independent PLC network wants to control a printout via the printer of the first PLC network, synchronization must be established between the said PC and the printer as respective communication stations.

For the purpose of synchronization, it is possible, for example, in each case to start and to run a time-consuming handshake operation between the said communication stations and then to exchange corresponding basic information by means of which the synchronization is carried out. Due to the increased time consumed for the synchronization, a user data rate is also reduced, by means of which the actual user data are transmitted during the actual communication between the communication stations. The reason for this is that the synchronization must be performed time and again.

It is the object of the present invention to specify a method for synchronizing communication stations belonging to mutually independent PLC networks, without reducing a user data rate which provides for fast synchronization of the communication stations.

According to the invention, this object is achieved by a method which has the features of the characterizing clause of claim 1.

Accordingly, basic information, by means of which the synchronization is performed, is transmitted and received, respectively, at the same fixed times for synchronizing communication stations belonging to mutually independent PLC networks with an in each case basic line frequency. The basic information is in each case transmitted and received, respectively, at the same time, in each case referred to a cycle of the line frequency of the PLC network in each case allocated to the respective communication station and, in addition, in each case at the same rate, in each case referred to a sequence of cycles of the line frequency of the PLC network in each case allocated to the respective communication station.

Thus, to synchronize the communication stations mentioned, the fact is utilized that the relevant PLC networks of the communication stations are based on a line frequency from which time-dependences can be derived. Thus, the line frequency also provides a first synchronization means which can be used for fixing times. Once such times are established, a correspondence between transmitting and receiving, for example, basic information for synchronization purposes between the communication stations can be achieved very rapidly. It is not necessary to perform any handshake sequences which consume a large amount of time. Synchronization can, therefore, be handled very rapidly.

If transmitting and receiving of basic information is not agreed for every cycle of the line frequency but in a manner which corresponds to a predetermined rate, it is also possible to ensure in this manner that times occur at which a communication station is transmitting while a relevant other one is receiving. However, the result is that additional time is available for transmitting user data. This also ensures rapid execution of synchronization processes but, at the same time, it also makes it possible to increase the user data rate for transmission of user data in the actual data transmission.

According to the invention, a respective communication station of a PLC network uses as “synchronization clock” for the synchronization the line frequency in each case forming the basis of the PLC network, and no longer a specific “clock” for the relevant PLC network as before, for example a time slot, as is the case in TDD (time division duplex) methods.

An advantageous embodiment of the invention is the subject matter of a subclaim.

Accordingly, the cyclic repetition of transmitting and receiving basic information for synchronizing the PLC stations is controlled by an algorithm which is the same for the PLC stations. Control by an algorithm has the advantage that the said rate can be changed or can be adapted to changed conditions by changing the algorithm. As a result, an optimization between the time consumed for the synchronization and a high user data rate can be achieved in an existing system.

In the text which follows, an exemplary embodiment of the invention is explained in greater detail with reference to a drawing, in which:

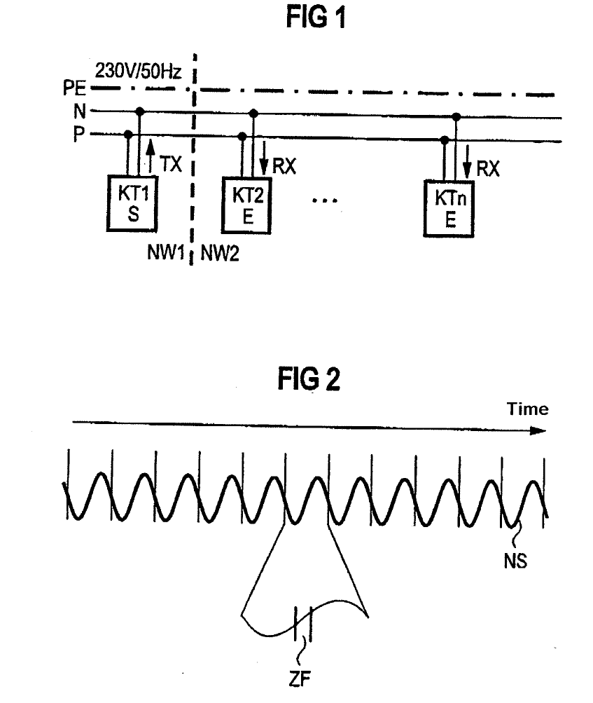

FIG. 1 shows a known PLC network with a number of possible communication stations,

FIG. 2 shows an example of a time window for transmitting basic information for synchronization purposes according to the invention, and

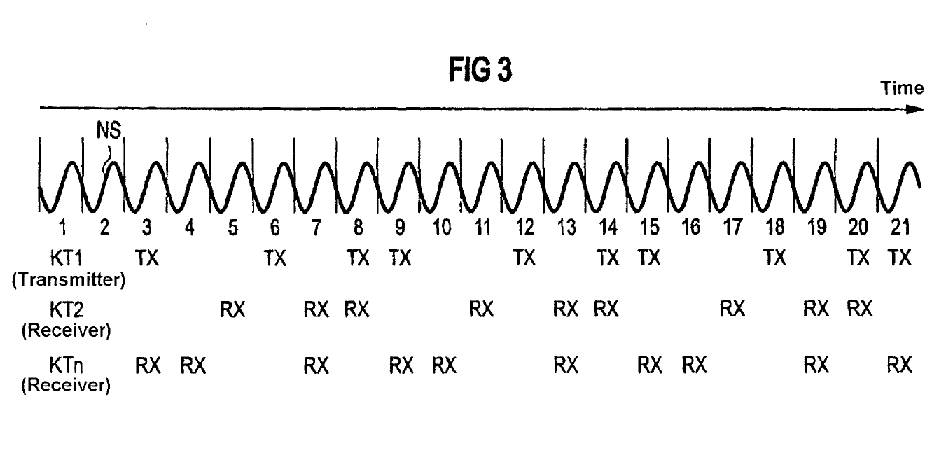

FIG. 3 shows an example of the synchronization mechanism according to the invention, using time windows according to FIG. 2.

FIG. 1 shows a PLC system with 1 to n communication stations KT1 to KTn which are connected to a 230V/50 Hz power supply system with a protective earth PE, a neutral N and a phase P.

In the system shown, the first communication station KT1 is a transmitter S which generally sends an item of transmit information TX to the communication stations KT2 and KTn located within the transmitting area of the communication station KT1. In the system shown in FIG. 1, the communication stations KT2 and KTn are respective receivers E which receive as receive information RX the transmit information TX sent by the communication station KT1.

The first communication station KT1 is part of a first PLC network NW1 which, for example, is the in-house PLC network of a company A. The communication stations KT2 and KTn are part of a second PLC network NW2 which, for example, is the in-house PLC network of a company B. The two in-house PLC networks NW1, NW2 are independent of one another. The networks NW1, NW2 are in each case associated with a line frequency which is given by the power supply system to which the communication stations KT1 to KTn are connected. In the present case, this is the same power supply system in each case.

It will be assumed for the exemplary embodiment according to FIG. 1 that the first communication station KT1 of the first independent PLC network NW1 is a PC which sends a document to the PCs KT2 to KTn of the second independent PLC network NW2.

For the exchange of information to function, the respective communication stations KT1, KT2 and KTn must be synchronized. For this purpose, the communication station KT1 wishing to transmit sends, e.g. within any cycle of the line voltage NS (FIG. 2), basic information suitable for synchronization at a fixed time to all communication stations located within the transmitting area of the communication station wishing to transmit. In the exemplary embodiment according to FIG. 1, these are communication stations KT2 and KTn.

In FIG. 2, the variation of the line voltage NS is shown with respect to time. One cycle is drawn enlarged. During this cycle, an exemplary time window ZF is marked, which, in the present case, defines the abovementioned fixed time for transmitting basic information. According to FIG. 2, the zero transition in the positive direction of the variation of the line voltage NS has been selected as such a possible time.

So that the exchange of basic information does not need to be repeated in every cycle and thus leads to unnecessary reduction of the user data rate for the network, it is possible to define an algorithm according to which times for transmitting basic information are selected. FIG. 3 shows such an algorithm. According to this algorithm, the communication station KT1 wishing to transmit transmits basic information only in every third, second and first cycle when this is received in the same manner by the receiving communication stations KT2 and KTn. The decisive factor is that the algorithm is defined in such a manner that the basic information is available in every case for all communication stations to be received within a time window to be defined.

In the actual exemplary embodiment according to FIG. 3, the first communication station KT1 sends basic information as an item of transmit information TX in each case at the zero transitions of the line voltage NS in the positive direction at times 3, 6 and 8, 9, 12 and 14, 15, 18 and 20, 21 etc.

The receiving communication stations KT2 and KTn attempt to read basic information in accordance with the rate of the communication station KT1 at the zero transitions of the line voltage NS in the positive direction with a corresponding distribution of times over a number of cycles. The starting times of the individual communication stations KT2 and KTn to be received are possibly different, as is also indicated in FIG. 3. The communication station KT2 starts to read the basic information according to FIG. 3 at times 5 and 7 and then continues at times 8, 11 and 13, then 14, 17 and 19, then 20 etc. For the receiving communication station KTn, times 3, then 4, 7 and 9, then 10, 13 and 15, then 16, 19 and 21 etc. are relevant. Thus, times 8, 14 and 20 are the common times according to FIG. 3 for the receiving communication station KT2, in which the basic information transmitted by the transmitting communication station KT1 in the form of transmit information TX can be received by the communication station KT1 as receive information RX. This correspondingly applies to a communication station KTn where, according to FIG. 3, it is times 3, 9, 15 and 21 at which the relevant information of communication station KT1 can be received by communication station KTn.

1. A method for synchronizing communication stations in mutually independent PLC networks with a respective line frequency by transmitting and receiving basic information by means of which the synchronization is effected, characterized in that the respective communication stations transmit and receive the basic information in each case at the same time, in each case referred to a cycle of the line frequency of the PLC network in each case allocated to the respective communication station and in each case in a preset algorithm, in each case referred to a sequence of cycles of the line frequency of the PLC network in each case allocated to the respective communication station.
